(19) United States
(12) Patent Application Publication
(10) Pub. No.: US 2023/0263106 A1
(43) Pub. Date: Aug. 24, 2023

(54) PLANT HOLDING DEVICE

(71) Applicant: PhytonIQ Technology GmbH, Oberwart (AT)

(72) Inventor: Martin PARAPATITS, Oberwart (AT)

(21) Appl. No.: 17/794,222

(22) PCT Filed: Feb. 18, 2020
(86) PCT No.: PCT/EP2020/054144

§ 371 Date: Jul. 20, 2022

(30) Foreign Application Priority Data
Feb. 26, 2019 (AT) A50151/2019
Aug. 29, 2019 (AT) A50747/2019

(51) Int. Cl. A01G 9/029; A01G 31/02

(52) U.S. Cl. CPC A01G 9/0297; A01G 9/0295; A01G 31/02

(57) ABSTRACT

The invention relates to a support device for plants, comprising a support trellis (2), said support trellis (2) having a plurality of essentially parallel support fillets (4), slit-type openings (5) being provided between individual support fillets (4)

The invention relates to a holding device for plants according to the preamble of the independent patent claim.

According to the state of the art, aeroponics is a method in which plants are cultivated without substrate. In this, both the above-ground plant parts (such as leaves, stems, fruits etc.) and the underground plant parts (such as roots, tubers etc.) are in an exposed location in a gaseous atmosphere. The special feature compared to conventional cultivation of plants in a growth substrate such as soil is that the underground plant parts are also exposed.

In aeroponics, both irrigation and nutrient supply are provided by means of an aerosol, which may optionally contain fertilizers, growth promoters and other substances. The aerosol is usually atomized at regular intervals to ensure continuous moisture in the area of the underground plant parts.

For plants with greater stem diameters or tubers, holding devices are usually used which can hold individual plants. This, however, is not preferred for smaller or pressure-sensitive plants, which is why alternative holding devices have to be used.

Such holding devices usually provide the possibility of a two-dimensional cultivation of a plurality of plants, such as in a holding frame.

Existing plant holders often do not offer the possibility to leave plants in the same holder from sowing to harvesting. The associated steps of transplanting can, on the one hand, affect the growth of the plants and they are, on the other hand, detrimental to the economics of cultivation.

Therefore, it is an object of the present invention to overcome the disadvantages of the state of the art and to create a holding device for plants which in particular permits continuous cultivation of the plants from sowing to harvesting in an aeroponic system.

Thus, the invention relates to a holding device for plants comprising a holding grid.

Optionally, it is provided that the holding grid comprises a plurality of holding webs or bars which are substantially parallel to one another, wherein gap-shaped openings are provided between individual holding webs.

This allows seeds to be introduced into the holding device and remain there, provided that their smallest spatial extent is greater than the width of the gap-shaped opening. The gap-shaped design of the opening permits a sufficient draining of liquids so that the risk of rotting of the seeds in the germination stage is reduced. After germination of the seeds, the openings offer enough space for the spreading of the forming roots of the plants.

The holding grid described herein may in particular have a main extension plane and a height arranged substantially orthogonal to the main extension plane.

Optionally, the width of the holding web or webs is between 1 mm and 10 mm, preferably between 1 mm and 5 mm. Optionally, the width of a gap-shaped opening or openings is between 0.1 mm and 2 mm, preferably between 0.2 mm and 1 mm. Preferably, the width of the holding webs and the openings is adapted to the plant to be cultivated. The width of the holding webs or the openings, respectively, refers in particular to their smallest dimension of the opening in the main extension plane of the holding grid.

If the above mentioned elements do not have a constant width, the indicated widths refer in particular to the average width of these elements.

Optionally, it is provided that a holding web, preferably at least two adjacent holding webs, has/have a cross section tapering at least on one side. If the tapering portion is arranged on the side of the holding device on which the seeds are sown in the intended state, the gap-shaped openings are widened in sections so that the seeds preferably come to lie in the area of the openings. This widening in sections of the gap-shaped openings is provided in particular with respect to the height direction of the holding grid.

Optionally, the width of a holding web in the area of the first surface of the holding grid may be different from the width of the holding web in the area of the second surface of the holding grid. The first surface may in particular be a support surface on which the seeds rest when the holding device is used as intended. The second surface may in particular be a lower surface that faces away from the support surface when the holding device is used as intended.

Preferably, the width of a holding web in the area of the first surface may be smaller than the width of the holding web in the area of the second surface. Optionally, the width in the area of the first surface is smaller by at least 20%, at least 30% or at least 50% than the width in the area of the second surface.

Thus, the contact between the seed and the holding grid is minimized, further reducing the risk of rotting due to fluid accumulation.

For this purpose, the cross section of the holding web/s is preferably of trapezoid, circular arc-shaped or triangular design at least in sections. However, other geometries allowing a widening in sections of the gap-shaped opening, in particular in the height direction of the holding grid, may also be provided.

Optionally, it is provided that the gap-shaped opening is divided into several elongated gap sections by a dividing web. This may increase the stability of the holding grid, it may in particular prevent or minimize bending.

In certain embodiments, no dividing web may be provided, in which case each gap-shaped opening comprises only a single elongated gap section. Thus, a gap-shaped opening may optionally comprise one or more gap sections. Optionally, a single gap section may have a length between 2 cm and 50 cm, preferably between 5 and 15 cm.

Optionally, it is provided that the length of a gap-shaped opening or multiple gap-shaped openings is between 5 cm and 50 cm, preferably between 20 cm and 40 cm. Preferably, all gap-shaped openings have the same length. The length of an opening refers in particular to that dimension of the opening in the main extension plane of the holding grid, which is orthogonal with respect to the width of the opening.

Optionally, it may be provided that the holding grid is substantially rectangular. Optionally, the holding grid may also be square.

Optionally, it is provided that the holding grid is arranged in a frame element. Preferably, the frame element is a holding frame, into which the holding grid can be inserted and does not need to be fastened further. Thereby, the holding grid can be easily removed from the holding element.

Optionally, it is provided that the holding grid can be inserted into the frame element with a positive fit. Thereby, an easy removal of the holding grid is possible. For example, the removal of the holding grid may be advantageous when sowing or harvesting plants. For example, the frame element may remain permanently in an aeroponic system, while the holding grid may be removed from the frame element. Optionally, the holding grid can be locked to the frame element by connecting means or latching means.

Optionally, it is provided that a support layer promoting plant growth is arranged on the holding grid.

Preferably, the support layer may rest on the holding grid. In the context of the present invention, the term “promoting plant growth” and variations thereof refers to the property that a substance, in particular the support layer, contains an agent or component that can promote the growth of a plant. For example, such an agent or component may be a nutrient, a fertilizer, a growth promoter or a germination promoter.

The support layer may be formed such that it is able to stabilize the position of seeds, plants, parts of a plant or the like. Thus, the support layer is preferably a continuous layer. However, the support layer may be partially permeable for certain substances, as long as it fulfils the required function described above. For example, the support layer may be permeable or partially permeable for water. Optionally, it may be provided that the support layer fully covers the holding grid.

Optionally, it may be provided that the holding grid has a mesh width of 1 mesh/cm to 10 mesh/cm. Optionally, the dimensioning of the mesh width is adapted to the cultivated plants. Preferably, the mesh width is chosen such that the cultivated plants are stabilized by the holding grid and do not fall through it.

Optionally, it may be provided that the holding grid has a projecting frame on the periphery, the height of the frame preferably corresponding to the thickness of the support layer.

This allows for a particularly simple arrangement of the support layer on the holding grid. Optionally, a precursor of the support layer may be applied to the holding grid, the frame acting as a spacer for determining the thickness of the support layer. For example, a doctor blade may be used for the application, which is run over the holding grid while resting against the frame. Thus, the height of the frame determines the thickness of the support layer.

For example, a precursor may be a pre-gelled or pre-polymerized mixture, which subsequently cures or hardens for forming the support layer. The precursor may have a certain strength, which allows an arrangement on the holding grid. However, a precursor may also be a liquid solution of a gelable and/or polymerizable agent. In this case, during the production of the support layer, it is preferred to position the holding grid on a flat surface to allow retention of the precursor in the area of the holding grid.

Optionally, it may be provided that the support layer comprises a preferably gel-like polymer or is a gel-like polymer. Optionally, it may be provided that the gel-like polymer is a biopolymer. The biopolymer may comprise or consist of at least one of the following: agar, gellan, gelatin, sodium alginate or (hydroxy)-alkyl cellulose.

For the purpose of the invention, a gel-like polymer may be a polymer or a polymer mixture with a gel structure. A gel structure denotes a disperse system comprising at least one solid component and one liquid component. The solid component forms a three-dimensional network, the pores of which are filled by a fluid.

Optionally, it may be provided that the biopolymer contains agar in a concentration of 1 wt% to 20 wt%.

Optionally, it may be provided that the support layer is water-soluble. Optionally, the support layer may also be only partially water-soluble.

In the context of the present invention, “water-soluble” means that a substance dissolves in water to form an aqueous solution. Under the influence of the aerosol generated in an aeroponic system, the support layer can slowly dissolve. Preferably, the solubility of the support layer is chosen such that it takes some days up to some weeks until the support layer is completely dissolved. Preferably, this time period is adapted to the germination period or the growth period, respectively, of the plants. Advantageously, the support layer is not completely dissolved until the plants have germinated and do not fall through the holding grid.

Optionally, it may be provided that the support layer has a thickness of 1 mm to 20 mm. Preferably, the thickness of the support layer is adapted to the properties of the plants to be cultivated.

Optionally, it may be provided that the support layer contains fertilizers, germination promoters and/or growth promoters.

Optionally, it is provided that the holding grid comprises or consists of steel, in particular stainless steel. As a result, the holding grid is easy to clean and it has advantageous mechanical properties.

Further, a method for producing a holding device is disclosed. The method comprises the following steps: preparing an aqueous polymer solution; applying and/or pouring a precursor of the support layer onto the support grid; and forming the support layer. Optionally, the precursor may be a partially gelled and/or a partially polymerized polymer. Optionally, the step of forming the support layer may comprise gelling and/or polymerizing the precursor. Optionally, a sealing element may be provided, which is arranged below the holding grid when applying and/or pouring the precursor. Thereby, the liquid precursor may be retained in the area of the later support layer.

Further features of the invention become apparent from the patent claims, the figures and the following description of exemplary embodiments.

In the figures:

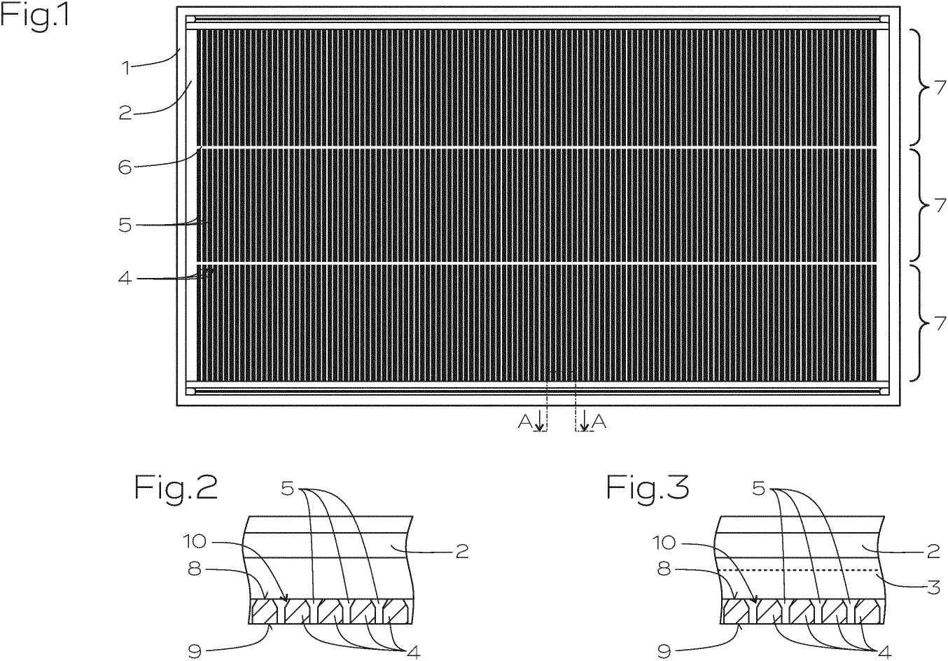

FIG. 1 shows a plan view of a first exemplary embodiment of a holding device;

FIG. 2 shows a lateral sectional view of the first exemplary embodiment of a holding device in detail;

FIG. 3 shows a lateral sectional view of a second exemplary embodiment of a holding device according to the invention in detail;

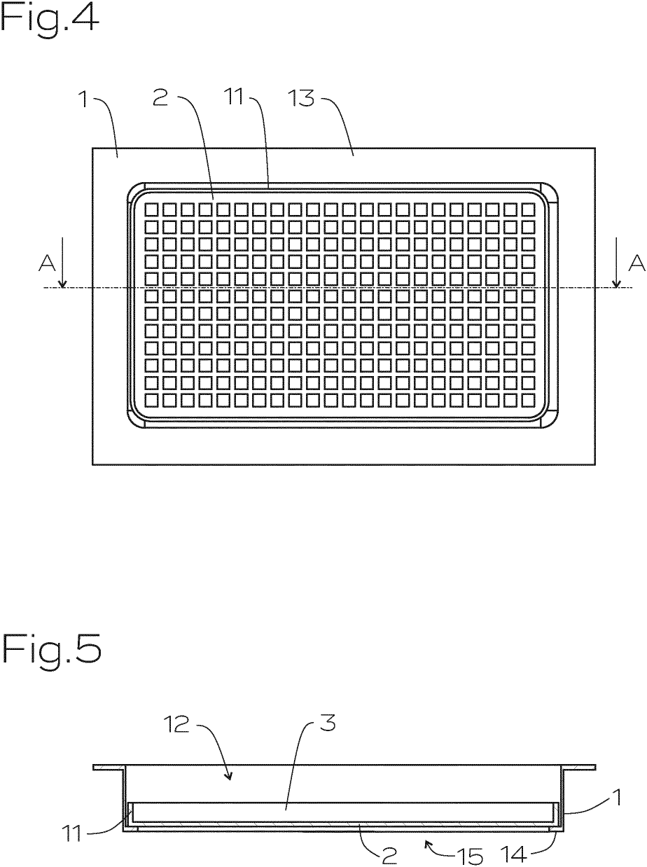

FIG. 4 shows a plan view of a third exemplary embodiment of a holding device; and

FIG. 5 shows a lateral sectional view of the third exemplary embodiment of the holding device.

FIG. 1 shows a plan view of a first exemplary embodiment of a holding device. The holding device comprises a frame element 1, in which a holding grid 2 is arranged. The holding grid 2 is form-fittingly inserted in a corresponding recess of the frame element 1.

The holding grid 2 comprises a plurality of holding webs 4 extending parallel to each other, wherein gap-shaped openings 5 are formed between the holding webs 4. Orthogonal to the longitudinal extension of the holding webs 4, dividing webs 6 are provided which divide the openings 5 into several elongated gap sections 7. In this exemplary embodiment, each opening 5 consists of three gap sections 7 arranged in succession in the longitudinal direction of the openings 5.

The dividing webs 6 serve to stabilize the holding grid 2 and are in particular to prevent bending or spreading apart of the holding webs 4.

In this exemplary embodiment, the holding grid 2 has a rectangular shape, with external dimensions of approximately 50 cm × 27 cm. The holding webs 4 have a length of about 25 cm. Accordingly, also the openings 5 have a length of about 25 cm, wherein, with three gap sections 7 per opening 5, each gap section 7 has a length of about 8 cm.

In FIG. 1, the first surface 8 of the holding grid 2 can be seen. In this exemplary embodiment, the first surface 8 is that side where, in the intended use of the device, the seeds come to lie; i.e., alternatively, the first surface 8 may also be referred to as support surface.

FIG. 2 shows a lateral sectional view of the exemplary embodiment of the holding device according to the invention in detail, wherein reference is made in particular to the design of the holding webs 4 of the holding grid 2.

The holding webs 4 have a trapezoidal cross-section in the upper section, the holding webs 4 thus taper in the direction of the support plane on which the seeds or the plants are placed when the holding device is used as intended. In the area of the first surface 8 of the holding grid, the holding webs 4 have a width of about 2 mm, while in the area of the second surface 9, they have a width of about 3 mm.

The angle of inclination of the bevels 10 of the holding webs 4 is about 60° in this exemplary embodiment.

Due to this geometry of the holding webs 4, the openings 5 widen in the direction of the support plane, substantially with a Y-shaped geometry. As a result, the width of the openings 5 in the area of the first surface 8, i.e., the support plane, is greater than in the area of the underside of the holding grid. In particular, the width of the openings 5 in the area of the support plane is about 2 mm, while it is about 1 mm in the area of the second surface 9, i.e., the underside.

As a result, seeds are preferably placed in the area of the openings 5, which reduces their support surface on the holding grid 2. Thus, the risk of rotting due to accumulating liquid in the area of the seeds can be effectively reduced.

The holding device according to this embodiment is among other things adapted to receive and retain seeds with a substantially spherical shape and a diameter of not less than 1 mm.

FIG. 3 shows a lateral sectional view of a second exemplary embodiment of the holding device in detail. The embodiment of FIG. 3 has the same features as the embodiment shown in FIGS. 1 and 2 and is thus not explained in detail here. In addition to the features described above, a support layer 3 promoting plant growth made of agar is arranged on the holding grid 2. In this exemplary embodiment, the support layer 3 is formed of a gel containing 3 wt% agar in water. Additionally, the gel contains a universal fertilizer as a fertilizer in a concentration of about 10 mg/kg. The support layer 3 extends substantially over the entire surface of the holding grid.

FIG. 4 shows a plan view of a third exemplary embodiment of a holding device. The holding device comprises a frame element 1 and a holding grid arranged in the frame element 1. In this exemplary embodiment, the frame element 1 is of rectangular design. It comprises a receiving area 12 formed for receiving the holding grid 2. The geometry of the receiving area 12 is dimensioned such that the holding grid 2 can be inserted into the receiving area 12 in a form-fitting manner.

Additionally, the frame element 1 has a projecting edge region 13, which can be used to attach the frame element 1 to a bracket, for example.

The holding grid 2 has a frame 11 encircling the holding grid 2. In this exemplary embodiment, the frame 11 has a height of about 2 mm and serves to facilitate the production of the support layer 3, as described below. The support layer 3 fully covers the holding grid 2, but is not shown in FIG. 4 for clarity. In this exemplary embodiment, the support layer 3 is formed of a gel containing 3 wt% agar in water. Additionally, the gel contains a universal fertilizer as a fertilizer in a concentration of about 10 mg/kg.

The size of the holding grid 2 is chosen such that a form-fitting insertion into the receiving area 12 of the frame element 1 is possible. In this exemplary embodiment, the average mesh width of the holding grid 2 is about 2 mesh/cm. Depending on the plant to be cultivated, the mesh width may vary and be adapted accordingly in other exemplary embodiments.

The support layer 3 of the present exemplary embodiment was formed by pouring a precursor of the support layer. In this exemplary embodiment, the precursor is a heated aqueous solution containing agar and a fertilizer. For pouring, the holding grid 2 is placed on a flat surface, whereupon the precursor is poured onto the holding grid 2.

The flat surface seals the holding grid 2 at the bottom, preventing leakage of the liquid precursor. The frame 11 limits the pouring height and thus the thickness of the support layer 3. During cooling, the precursor gels and forms the support layer 3. The support layer 3 thus formed is soluble in water and, under normal conditions in an aeroponic system, has completely dissolved after about two weeks with regular sprinkling with water.

FIG. 5 shows a lateral sectional view of the exemplary embodiment of a holding device according to the invention shown in FIG. 4 along the sectional plane A-A in FIG. 4. FIG. 5 shows the holding grid 2, which is form-fittingly inserted into the receiving area 12 of the frame element 1. Here, the holding grid 2 rests on retaining tabs 14, which are formed to surround the frame element 1 on the inside. As a result, the frame element 1 has a clearance 15 in its interior, which is preferably adapted to the areal extent of the area of the holding grid 2 provided with a grid.

In FIG. 5, the support layer 3 is shown, which was manufactured as described above. In this exemplary embodiment, the support layer 3 has a height of about 2 mm, which substantially corresponds to the height of the frame 11. Depending on the composition of the precursor or the casting material for the support layer 3, it may also be higher or lower than the frame 11. For example, a reduction in volume may occur during gelation or curing of the precursor.

List of reference signs

| | |
|---|---|
| 1 | Frame element |
| 2 | Holding grid |
| 3 | Support layer |
| 4 | Holding web |
| 5 | Opening |
| 6 | Dividing web |
| 7 | Gap section |
| 8 | First surface |
| 9 | Second surface |
| 10 | Bevel |
| 11 | Frame |
| 12 | Receiving area |
| 13 | Edge region |
| 14 | Retaining tab |
| 15 | Clearance |

1. A holding device for plants, comprising a holding grid (2), characterized in that the holding grid (2) comprises a plurality of holding webs (4), which are substantially parallel to one another, wherein gap-shaped openings (5) are provided between individual holding webs (4).

2. The holding device according to claim 1, characterized in that the width of a holding web (4) is between 1 mm and 10 mm, preferably between 1 mm and 5 mm.

3. The holding device according to claim 1, characterized in that the width of a gap-shaped opening (5) is between 0.1 mm and 2 mm, preferably between 0.2 mm and 1 mm.

4. The holding device according to claim 1, characterized in that a holding web (4), preferably at least two adjacent holding webs (4), have a cross section tapering at least on one side.

5. The holding device according to claim 4, characterized in that the cross section of the holding web (4) or the holding webs (4) is, at least in sections, of trapezoidal, circular arc-shaped or triangular design.

6. The holding device according to claim 1, characterized in that the holding grid (2) has a first surface (8) and a second surface (9), and in that a holding web (4) has a smaller width in the area of the first surface (8) than in the area of the second surface (9).

7. The holding device according to claim 6, characterized in that the width of the holding web (4) in the area of the first surface (8) is smaller by at least 20 % than the width of the holding web (4) in the area of the second surface (9).

8. The holding device according to claim 1, characterized in that the gap-shaped opening (5) is divided into multiple elongated gap sections (7) by a dividing web (6).

9. The holding device according to claim 1, characterized in that a gap section (7) has a length between 2 cm and 50 cm, preferably between 5 and 15 cm.

10. The holding device according to claim 1. characterized in that the gap-shaped opening (5) has a length between 5 cm and 50 cm, preferably between 20 cm and 40 cm.

11. The holding device according to claim 1, characterized in that the holding grid (2) is arranged in a frame element (1).

12. The holding device according to claim 1, characterized in that a support layer (3) promoting plant growth is arranged on the holding grid (2).

13. The holding device according to claim 12, characterized in that the support layer (3) comprises a preferably gel-like polymer or is a gel-like polymer.

14. The holding device according to claim 13, characterized in that the biopolymer comprises or consists of at least one of the following: agar, gellan, gelatin, sodium alginate or (hydroxy)-alkyl cellulose.

15. The holding device according to claim 12, characterized in that the support layer (3) contains fertilizers, germination promoters and/or growth promoters.
